(19) United States
(12) Patent Application Publication
(10) Pub. No.: US 2004/0247909 A1
(43) Pub. Date: Dec. 9, 2004

(54) Matte, biaxially oriented polyester foil, method for the production thereof and its utilization

(76) Inventors: Stefan Bartsch, Wiesbaden (DE); Herbert Peiffer, Mainz (DE); Bart Janssens, Wiesbaden (DE)

Correspondence Address: Klaus Schweitzer, ProPat, 425 C South Sharon Amity Road, Charlotte, NC, 28211, US

(21) Appl. No.: 10/492,999

(22) PCT Filed: Oct. 11, 2002
(86) PCT No.: PCT/EP02/11401

(30) Foreign Application Priority Data
Oct. 23, 2001 (DE) 101 52 141.3

(51) Int. Cl. B32B 27/06

(52) U.S. Cl. 428/480

(57) ABSTRACT

The invention relates to a matte, biaxially oriented polyester foil consisting of at least 60 percent by weight of thermoplastic polyester, pigments system favoring the degree of mattness and other common additives. The foil has planar orientation Δp≦0.164 and is characterized by a matte surface or appearance. The invention also relates to a method for the production of said foil and to its utilization as packaging foil or for application in the industrial sector.

The invention relates to a matt, biaxially oriented polyester film which consists of at least 60% by weight of a thermoplastic polymer, of pigment systems enhancing the mattness of the film, and of other conventional additives, and has a planar orientation Δp of ≦0.164 and features a characteristic matt surface or appearance. The film is very suitable for use as a packaging film or for applications in the industrial sector. The invention further relates to a process for the production of the film and to its use.

EP-A-0 347 646 describes a biaxially oriented polyester film which has at least one overlayer (A) which contains a filler in a concentration of from 0.5 to 50%, the diameter of this filler being in a certain ratio to the layer thickness of the overlayer. In addition, the overlayer has a certain thickness and a certain degree of crystallization which is determined with the aid of Raman spectroscopy. As a consequence of the topography of the overlayer A, the film is especially suitable for magnetic recording tapes. There is no information in the document about the achieved gloss of the overlayer A.

EP-A-0 053 498 describes a multilayer, biaxially oriented polyester film which has a transparent base layer and, on at least one side of this layer, a further layer having a matt appearance. This layer having a matt appearance consists substantially of a polyethylene terephthalate copolyester whose copolymer contains

H(—OCH₂CH₂—)ₙOH or

H(—OCH₂CH₂—)ₙ₋₁O—C₆H₄—O—(CH₂)CH₂O—)ₙ₋₁H or

H(—OCH₂CH₂—)ₙ₋₁O—C₆H₄—X—C₆H₄—O—(CH₂)CH₂O—)ₙ₋₁H

(n is an integer from 2 to 140, X is —CH₂—, —C(CH₃)₂— or —SO₂—) and inert organic particles having a median diameter of from 0.3 to 20.0 μm in a concentration of from 3 to 40%, based on the layer having a matt appearance. The film features high mattness (gloss≦15) and a transparency which is still acceptable for certain applications (≧60%). A disadvantage of this film is that it is not printable in the case of an ABA structure and cannot be processed (on high-speed machines) in the case of an AB structure. Moreover, it has deficiencies in the production.

The prior art likewise discloses matt, biaxially oriented polyester films having a milky appearance.

DE-A 23 53 347 describes a process for producing a monolayer or multilayer, milky polyester film, which comprises forming a loosely blended mixture of particles of a linear polyester with from 3 to 27% by weight of a homopolymer or copolymer of ethylene or propylene, extruding the blend as a film, quenching and biaxially orienting the film by stretching it in mutually perpendicular directions, and heat setting the film. A disadvantage of the process is that regrind (substantially a mixture of polyester raw material and ethylene or propylene copolymer) which occurs in the production of the film can no longer be used, since the film otherwise becomes yellow. This makes the process uneconomic and the film produced with the regrind was not able to become established on the market. When the concentration of the copolymer in the polyester is increased, the film generally loses its milky character and becomes white with high opacity.

U.S. Pat. No. 3,154,461 claims a process for producing a biaxially oriented film composed of thermoplastic (for example polyethylene terephthalate, polypropylene), said film having a matt surface and containing incompressible particles (for example, calcium carbonate, silicon dioxide) in a size of from 0.3 to 20.0 μm and in a concentration of from 1.0 to 25.0%. Also claimed in this application is a matt film produced by the process of the present invention. However, this film is too opaque for many applications.

However, the packaging industry has a high demand for transparent, highly glossy polymer films such as biaxially oriented polypropylene or biaxially oriented polyester films. In addition, there is an increasing demand for those transparent films in which at least one surface layer is not high-gloss, but rather features a characteristic matt appearance and thus, for example, confers on the packaging a particularly attractive and thus commercially effective appearance.

A film produced in accordance with EP-A-0 347 646 (Example 1) did not have such a desired matt surface. The gloss of this surface is outside the range claimed in the present application.

It is therefore an object of the present invention to provide a matt, biaxially oriented polyester film which does not have the disadvantages of the prior art films.

The invention provides a matt, biaxially oriented polyester film which is composed of at least 60 mol % of a thermoplastic polyester, of pigment systems enhancing the mattness of the film, and of other conventional additives, wherein the planar orientation Δp of the film is ≦0.164. The invention further relates to a process for producing this film and to its use.

The film of the invention is matt on at least one side and features in particular outstanding optical properties, i.e. high mattness (i.e. low gloss) with simultaneously good transparency, very good producibility and very good processibility. It can therefore be processed on high-speed processing machines. It is also possible to feed offcut material which occurs in the course of film production back to the production process as regrind in an amount of up to 60% by weight, based on the total weight of the film, without the physical and optical properties of the film being significantly adversely affected.

To achieve high mattness, very good producibility and very good processibility of the film, according to the achievement of the object, the planar orientation Δp of the film of the invention has to be smaller than a predefined numerical value. This numerical value is laid down by Δp=0.164.

For the production of a film having low gloss, a comparatively low planar orientation Δp is accordingly required. When the planar orientation Δp of the film is greater than the value specified, the achieved mattness of the film and the producibility of the film for the purposes of the present invention are poor. When, in contrast, the planar orientation Δp of the film is smaller than in the present invention, the mattness of the film and the producibility of the film invention are good.

In one embodiment of the invention, the planar orientation Δp of the film of the invention is preferably less than 0.161 and especially less than 0.158.

In the preferred embodiment, the film features particularly high property values.

The film of the invention consists of at least 60% by weight, preferably at least 80% by weight, of a thermoplastic polyester. Suitable for this purpose are, for example, polyesters of ethylene glycol and terephthaiic acid (=polyethylene terephthalate, PET), of ethylene glycol and naphthalene-2,6-dicarboxylic acid (=polyethylene 2,6-naphthalate, PEN), of 1,4-bishydroxymethylcyclohexane and terephthalic acid [=poly(1,4-cyclohexanedimethylene terephthalate), PCDT], and also of ethylene glycol, naphthalene-2,6-dicarboxylic acid and biphenyl-4,4′-dicarboxylic acid (=polyethylene 2,6-naphthalate bibenzoate, PENBB) or a mixture of these; preference is given to PET, PEN and PENBB. The remaining monomer units stem from other aliphatic, cycloaliphatic or aromatic diols or dicarboxylic acids.

Suitable other aliphatic diols are, for example, diethylene glycol, triethylene glycol, aliphatic glycols of the general formula HO—(CH₂)ₙ—OH where n is an integer from 3 to 6 (in particular propane-1,3-diol, butane-1,4-diol, pentane-1,5-diol and hexane-1,6-diol) or branched aliphatic glycols having up to 6 carbon atoms. Of the cycloaliphatic diols, mention should be made of cyclohexanediols (in particular cyclohexane-1,4-diol). Suitable other aromatic diols correspond, for example, to the formula HO—C₆H₄—X—C₆H₄—OH where X is —CH₂—, —C(CH₃)₂—, —C(CF₃)₂—, —O—, —S— or —SO₂—. In addition, bisphenols of the formula HO—C₆H₄—C₆H₄—OH are also very suitable.

Other aromatic dicarboxylic acids are benzenedicarboxylic acids, naphthalenedicarboxylic acids, for example naphthalene-1,4- or -1,6-dicarboxylic acid, biphenyl-x,x′-dicarboxylic acids, for example biphenyl-4,4′-dicarboxylic acid, diphenylacetylene-x,x′-dicarboxylic acids, for example diphenylacetylene-4,4′-dicarboxylic acid, or stilbene-x,x′-dicarboxylic acids. Of the cycloaliphatic dicarboxylic acids, mention should be made of cyclohexanedicarboxylic acids, in particular cyclohexane-1,4-dicarboxylic acid. Of the aliphatic dicarboxylic acids, the (C₃ to C₁₉)alkanedicarboxylic acids are particularly suitable, and the alkane moiety may be straight-chain or branched.

The polyesters can be prepared, for example, by the transesterification processes. These processes start from dicarboxylic esters and diols which are reacted with the customary transesterification catalysts, such as zinc salts, calcium salts, lithium salts, magnesium salts and manganese salts. The intermediates are then polycondensed in the presence of generally customary polycondensation catalysts such as antimony trioxide or titanium salts. The preparation may equally efficiently be effected by the direct esterification process in the presence of polycondensation catalysts. This starts directly from the dicarboxylic acids and the diols.

To achieve the desired mattness/the desired degree of mattness, the film generally contains a certain pigment system in an effective amount of from 1.0 to 10.0% by weight, based on the layer. The particle concentration is preferably from 1.1 to 9.0% by weight and especially from 1.2 to 8.0% by weight. Typical particle systems enhancing the mattness of the film are inorganic and/or organic particles, for example calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, calcium, barium, zinc or manganese salts of the dicarboxylic acids used, carbon black, titanium dioxide, kaolin or crosslinked polymer particles, for example polystyrene or acrylate particles.

In addition, mixtures of two and more different particle systems or mixtures of particle systems in the same composition but different particle size may also be selected. The particles may be added to the polymers of the film in the particular advantageous concentrations, for example as a glycolic dispersion during the polycondensation or preferably via masterbatches in the course of extrusion.

Preferred particles are SiO₂ in colloidal and in chainlike form. These particles are incorporated very efficiently into the polymer matrix.

The pigments used have a median diameter (d₅₀) in the range from 2.0 to 8.0 μm, the spread of the distribution of the diameter (expressed via the SPAN 98) being ≦1.8.

In a preferred embodiment, the film of the present invention contains a pigment system in which the median diameter is in the range from 2.1 to 7.9 μm and the spread of the distribution is less than 1.7. In particular, the median diameter is in the range from 2.2 to 7.8 μm, and the spread of the distribution is ≦1.6.

In another favorable embodiment, the film, in addition to the polyethylene terephthalate homopolymer or the polyethylene terephthalate copolymer, contains a further polymeric component I. This component I is a polyethylene terephthalate copolymer which consists of the condensation product of the following monomers or their derivatives which are capable of forming polyesters:

from 65 to 95 mol % of isophthalic acid;

from 0 to 30 mol % of at least one aliphatic dicarboxylic acid of the formula HOOC(CH₂)ₙCOOH where n is in the range from 1 to 11;

from 5 to 15 mol % of at least one sulfo monomer containing an alkali metal sulfonate group on the aromatic moiety of a dicarboxylic acid;

the stoichiometric amount of a copolymerizable aliphatic or cycloaliphatic glycol having from 2 to 11 carbon atoms required to form a 100 mol % of condensate; the percentages each being based on the total amount of the monomers forming component I. For a comprehensive description of component I, see also EP-A-0 144 878, which is incorporated herein by reference.

Component I is appropriately added as a further polymeric component of the film, and the proportion by weight may be up to 30% by weight. In this case, component I forms a blend or a mixture with the other polymers present in this layer, or else a copolymer by transesterification during the extrusion operation.

In the context of the present invention, mixtures refer to mechanical mixtures which are produced from the individual components. To this end, the individual constituents are generally combined as compressed shaped bodies of small size, for example lenticular or spherical granules, and mixed together mechanically with a suitable agitator. Another possibility for the preparation of the mixture is to feed component I and the appropriate polymers for the particular layer each separately to the extruder and to carry out the mixing in the extruder or in the downstream systems for conducting the melt.

In the context of the present invention, a blend is an alloy-like composite of individual components which can no longer be separated into the original constituents. A blend has properties like a homogeneous substance and can be characterized correspondingly by appropriate parameters.

In a favorable embodiment, the film having a matt appearance is characterized by the following parameter.

a) the roughness of the film, characterized by the Rₐ value, is in the range from 150 to 1000 nm, preferably from 175 to 950 nm and especially from 200 to 900 nm. Values smaller than 150 nm have adverse effects on the mattness of the surface; values larger than 1000 nm impair the optical properties of the film.

b) The measurement of the gas flow is in the range from 1 to 50 s, preferably in the range from 1 to 45 s. At values of above 50, the mattness of the film is adversely affected.

The film may likewise contain conventional additives, for example stabilizers and/or pigments (=fillers). The stabilizers used are advantageously, for example, phosphorus compounds such as phosphoric acid or phosphoric ester.

The total thickness of the film of the invention may vary within certain limits. It is from 3 to 500 μm, preferably from 4 to 300 μm, especially from 5 to 250 μm.

In the course of the production of the film, the appropriate melt is extruded through a flat-film die, the thus obtained film is solidified by drawing off on one or more roll(s), and is subsequently biaxially stretched (oriented), then heat-set and optionally corona- or flame-treated on the surface layer intended for treatment.

The biaxial stretching (orientation) is generally carried out sequentially, in which case preference is given to that stretching in which stretching is effected first longitudinally (in machine direction) and then transversely (at right angles to machine direction). In addition, the biaxial stretching of the film may also be effected simultaneously in a particular embodiment.

Initially, as is customary in extrusion processes, the polymers or the polymer mixtures is/are compressed and liquefied in an extruder, and the additives provided as additions may already be present in the polymer or in the polymer mixture. The melt is then compressed through a flat-film die (slot die), and the extruded melt is drawn off on one or more draw rolls, in the course of which the melt cools and solidifies to a prefilm.

The biaxial stretching is generally carried out sequentially. Preference is given to stretching the prefilm initially in longitudinal direction (i.e. in machine direction, =MD) and subsequently in transverse direction (i.e. at right angles to the machine direction, =TD). This leads to spatial alignment (orientation) of the polymer chains. The stretching in longitudinal direction can be carried out with the aid of two rolls rotating at different speeds in accordance with the desired stretching ratio. For transverse stretching, an appropriate tenter frame is generally used, into which the film is clamped at both edges and then stretched at both sides at elevated temperature.

The temperature at which the stretching is carried out may vary within a relatively wide range and depends upon the desired properties of the film. In general, the longitudinal stretching is carried out at a temperature in the range from 80 to 130° C. and the transverse stretching in the range from 90 to 150° C. The longitudinal stretching ratio is generally in the range from 2.5:1 to 6:1, preferably from 3:1 to 5.5:1. The transverse stretching ratio is generally in the range from 3.0:1 to 5.0:1, preferably from 3.5:1 to 4.5:1. Before the transverse stretching, one or both surface(s) of the film may be coated inline by the known processes. The inline coating may serve, for example, to improve adhesion of a metal layer or of a printing ink which might possibly be applied later, or else to improve the antistatic performance or the processing performance of the film.

For the production of a film having very high mattness and improved producibility (the film has a lesser tendency to tear in the course of stretching), it has been found to be essential to the invention for the planar orientation Δp of the film to be less than Δp=0.164, preferably ≦Δp=0.161 and especially ≦Δp=0.158. In this case, the roughness of the film is increased. This is manifested in improved mattness, better incorporation of the pigments into the polymer matrix and in improved transparency. The integrity of the film in the thickness direction also increases, which is in turn exhibited in improved process reliability of the film in the production process. As a consequence of the increased integrity in the thickness direction, the film has a lesser tendency to start and continue to tear during the production process.

It has been found that the important influencing parameters on the planar orientation Δp are the process parameters in the longitudinal stretching and in the transverse stretching, and also the SV value of the raw material used. The process parameters include in particular the stretching ratios in longitudinal and in transverse direction (λ_{MD} and λ_{TD}), the stretching temperatures in longitudinal and in transverse direction (T_{MD} and T_{TD}), the film web speed and the type of stretching, especially that in longitudinal direction of the machine.

When, for example, Δp values which are above the values of the invention (for example, planar orientation Δp=0.171) are obtained on a film plant, films of the invention can be produced by increasing the temperatures in the longitudinal stretching and in the transverse stretching and/or reducing the stretching ratios in longitudinal stretching and in the transverse stretching. Typical values for the parameters mentioned in the case of films which cannot be used for matt films of the present invention are, for example,

| | Longitudinal | Transverse |
|---|---|---|
| | stretching | stretching |
| Stretching | 100 to 115° C. | 100 to 115° C. |
| temperatures | | |
| Stretching ratios | 4.3 to 5.0 | 4.2 to 5.0 |

In the films of the invention, the temperatures and stretching ratios are generally within ranges as reproduced in the table below:

| | Longitudinal | Transverse |
|---|---|---|
| | stretching | stretching |
| Stretching | 120 to 135° C. | 120 to 140° C. |
| temperatures | | |
| Stretching ratios | 2.5 to 4.6 | 3.5 to 4.1 |

A further reduction in the stretching ratio λ_{MD} is not possible, since the film otherwise exhibits defects which are undesired. When, for example, the longitudinal stretching ratio λ_{MD} is reduced below a value of 2.5, transverse creases are obtained in the film and can be clearly seen, for example, in the metal layer after the metalization of the film.

When, for example, a machine is used to achieve a Δp of 0.173 with the parameter set λ_{MD}=4.5 and λ_{TD}=4.2, and the stretching temperatures in longitudinal and in transverse direction T_{MD}=114° C. and T_{TD}=121° C., increasing the longitudinal stretching temperature to T_{MD}=125° C. or increasing the transverse stretching temperature to T_{TD}=135° C. or reducing the longitudinal stretching ratio to λ_{MD}=3.8 or reducing the transverse stretching ratio to λ_{TD}=3.7 provides a Δp of 0.162. In this case, the film web speed was 340 m/min and the SV value of the material about 730. The temperatures specified relate to the particular roll temperatures in the longitudinal stretching and to the film temperatures which have been measured by means of IR (infrared) in the transverse stretching.

Generally, the desired values are achieved when, starting from a parameter set at which the film does not have the Ap values of the invention, either by

a) increasing the stretching temperature in MD by ΔT=3 to 15 K, preferably ΔT=5 to 12 K, and especially by ΔT=7 to 10 K or

b) lowering the stretching ratio in MD by Δλ=0.3 to 0.8, preferably by Δλ=0.35 to 0.7 and especially by Δλ=0.4 to 0.6 or

c) increasing the stretching temperature in TD by ΔT=4 to 15 K, preferably by ΔT=5 to 12 K and especially by ΔT=6 to 10 K or

d) reducing the stretching ratio in TD by Δλ=0.3 to 0.8, preferably by Δλ=0.35 to 0.7 and especially by Δλ=0.4 to 0.6.

Where appropriate, one or more of the above measures a) to d) may be combined together. It has been found to be particularly advantageous to combine the measures a) and b) together.

In a preferred embodiment, the film having a planar orientation of Δp≦0.164 is produced by combining the measures a) and b) in such a way that the following range between the stretching temperature in MD T_{MD} and the stretching ratio in MD is complied with:

110+3.0·λ_{MD}≦T_{MD}≦110+5.0·λ_{MD} eq. 1

In FIG. 1, this range is illustrated by the strip between the upper line and the lower line. When determining the conditions, the procedure may be as specified above. Compliance with eq. 1 ensures that the Δp values are always less than 0.164 and the film having optimum mattness is produced.

In the subsequent heat-setting, the film is kept at a temperature of from 150 to 250° C. over a period of from about 0.1 to 10 seconds. Subsequently, the film is wound up in the customary manner.

After the biaxial stretching, one or both surface(s) of the film is/are corona- or flame-treated by one of the known methods. The treatment intensity is generally in the range of above 45 mN/m.

To establish further advantageous properties, the film may additionally be coated by known processes. Typical coatings are layers having adhesion-promoting, antistatic, slip-improving or release action. One option is to apply the additional layers to the film by inline coating before the stretching step in transverse direction by means of aqueous dispersions.

The film is outstandingly suitable for use as a packaging film, for example as flexible packaging, or for applications in the industrial sector, for example in the embossing film or release film sector, and especially where its excellent optical properties and its good processibility are used to full effect. It is very particularly suitable for use on high-speed packaging machines.

The table 1 which follows summarizes the most important film properties.

| Film | | Inventive ranges | | | |
|---|---|---|---|---|---|
| properties | Unit | General | Preferred | Especially | Test method |
| Gloss, 60° | | <80 | <70 | <60 | DIN 67530 |
| Coefficient | | ≦0.6 | ≦0.5 | ≦0.40 | DIN 53375 |
| of friction | | | | | |
| COF | | | | | |
| Average | nm | 150 to 1000 | 175 to 950 | 200 to 900 | DIN 4768, |
| roughness Rₐ | | | | | cutoff of |
| | | | | | 0.25 mm |
| Measure- | sec | 1 to 50 | 1 to 45 | | internal |
| ment range | | | | | |
| for the gas | | | | | |
| flow | | | | | |
| Opacity | % | <90 | | | ASTM-D |
| | | | | | 1003-52 |
| Planar | | <0.164 | <0.161 | <0.158 | internal |
| orientation | | | | | |

The individual properties were tested as follows:

SV Value (Standard Viscosity)

The standard viscosity SV (DCA) is measured in dichloroacetic acid, based on DIN 53726.

The intrinsic viscosity (IV) is calculated from the standard viscosity as follows:

IV (DCA)=6.907·10⁻⁴ SV (DCA)+0.063096

Friction The friction is determined to DIN 53375. The coefficient of friction (COF) is determined 14 days after the production.

Surface Tension

The surface tension is measured by means of what is known as the ink method (DIN 53 364).

Opacity

The opacity is determined according to Hölz based on ASTM-D 1003-52, except that, to utilize the optimum measuring range, measurement is effected on four film plies lying one on top of the other and, instead of a 4 pinhole diaphragm, a 1° slot diaphragm is used.

Gloss

The gloss is determined to DIN 67 530. The reflector value was measured as a characteristic optical parameter for the surface of a film. Based on the standards ASTM-D 523-78 and ISO 2813, the angle of incidence is set to 20° or 60°. A light beam hits the flat test surface at the angle of incidence set and is reflected or scattered by it. The light beams incident upon the photoelectronic detector are displayed as a proportional electrical quantity. The measurement is dimensionless and has to be quoted together with the angle of incidence.

Surface Gas Flow Time

The principle of the test method is based on the air flow between one side of a film and a smooth silicon wafer plate. The air flows from the environment into an evacuated space, and the interface between film and silicon wafer plate serves as the flow resistance.

A round film specimen is placed on a silicon wafer plate in whose middle there is a hole which ensures the connection to the receptacle. The receptacle is evacuated to a pressure of less than 0.1 mbar. The time in seconds which is taken by the air to bring about a pressure rise of 56 mbar in the receptacle is determined.

Test conditions:

| | |
|---|---|
| test surface area | 45.1 cm² |
| weight applied | 1276 g |
| air temperature | 23° C. |
| air humidity | 50% relative humidity |
| total gas volume | 1.2 cm³ |
| pressure differential | 56 mbar |

Determination of the Planar Orientation Δp

The planar orientation is determined via the measurement of the refractive index with an Abbe refractometer in accordance with an internal operating procedure.

Sample preparation:

| | |
|---|---|
| Sample size and sample length: | 60 to 100 mm |
| Sample breadth: | corresponds to prism |
| | breadth of 10 mm |

To determine n_{MD} and a (=n_{z}), the sample to be analyzed has to be cut out of the film with the running edge of the sample coinciding exactly with TD (sample a), while, to determine n_{TD} and nₐ (=n_{z}), the running edge of the sample to be analyzed has to coincide exactly with MD (sample b). The samples have to be taken from the middle of the film web. Care has to be taken that the Abbe refractometer has a temperature of 23° C. With the aid of a glass rod, a little diiodomethane (n=1.745) or diiodomethane-bromonaphthalene mixture is applied to the lower prism, thoroughly cleaned before the measurement. The refractive index of the mixture has to be greater than 1.685. First the sample cut out in TD is applied thereto, in such a way that the entire prism surface is covered. A paper tissue is then used to flatten the film firmly onto the prism, so that the film lies firm and smooth. The excess liquid has to be removed by suction. Afterward, a little of the test liquid is dripped onto the film. The second prism is swung downwards and pressed on firmly. The right-hand knurled screw is then used to turn the indicator scale until a transition from light to dark can be seen in the viewing window in the range from 1.62 to 1.68. When the transition from light to dark is not sharp, the colors are brought together with the aid of the upper knurled screw in such a way that only a light and a dark zone are visible. The sharp transition line is brought with the aid of the lower knurled screw to the crossing point of the two diagonal lines (in the eyepiece). The value now indicated in the measuring scale is read off and entered into the test record. This is the refractive index in machine direction n_{MD}. The scale is now turned with the lower knurled screw until the range visible in the eyepiece is between 1.49 and 1.50.

The refractive index nₐ or n_{z} (in the thickness direction of the film) is now determined. So that the transition, which is only weakly visible, can be better seen, a polarization film is placed on the eyepiece. This has to be turned until the transition can be clearly seen. The same applies as for the determination of n_{MD}. When the transition from light to dark is not sharp (colored), the colors are brought together with the aid of the upper knurled screw in such a way that a sharp transition can be seen. This sharp transition line is brought with the aid of the lower knurled screw to the crossing point of the two diagonal lines and the value indicated on the scale is read off and entered into the table.

Subsequently, the sample is turned and the corresponding refractive indices n_{MD} and nₐ (=n_{z}) of the other surface side are measured and entered into a corresponding table.

After the determination of the refractive indices of sample a), the sample strip cut out in MD is laid on and the refractive indices n_{TD} and nₐ (=n_{z}) of sample b) are determined correspondingly. The strip is turned round and the values are measured for the B side. The values for the A side and the B side are combined to average refractive values. The orientation values are then calculated from the refractive indices by the following formulae:

Δn=n_{MD}−n_{TD}

Δp=(n_{MD}+n_{TD})/2−n_{z}

nₐᵥ=(n_{MD}+n_{TD}+n_{z})/3

When the planar orientation Δp cannot be directly measured on the matt film, it is determined by undertaking the measurement of a less opaque film which has been produced directly before or after the matt film having identical process parameters.

Measurement of the Median Particle Diameter d₅₀

The determination of the median particle diameter d₅₀ is carried out by means of laser on a ®Malvern Master Sizer by the standard method (other instruments are, for example, ®Horiba LA 500 or ®Sympathec Helos, which use the same measurement principle). To this end, the samples were introduced into a cuvette with water and this was then placed in the measuring instrument. The test procedure is automatic and also includes the mathematical determination of the d₅₀ value.

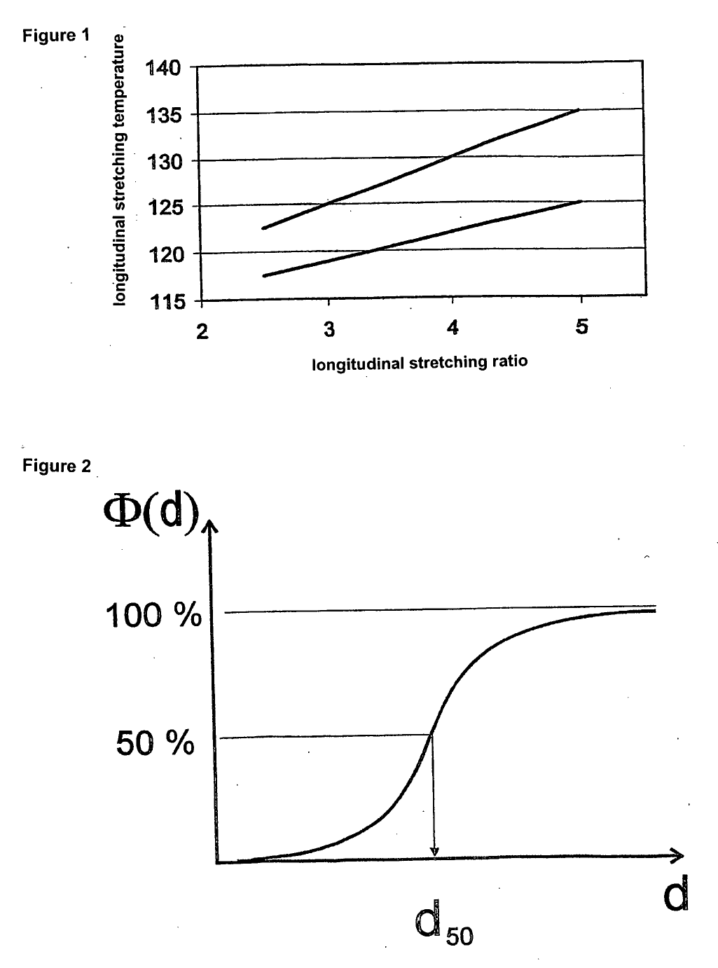

By definition, the d₅₀ value is determined from the (relative) cumulative curve of the particle size distribution: the point at which the 50% ordinate value cuts the cumulative curve immediately provides the desired d₅₀ value on the abscissa axis (cf. FIG. 2).

Measurement of SPAN 98

The determination of the SPAN 98 was carried out with the same test instrument as described above for the determination of the median particle diameter d₅₀. The SPAN 98 is defined as follows:

SPAN 98=(d₉₈−d₁₀)/d₅₀ eq. 2

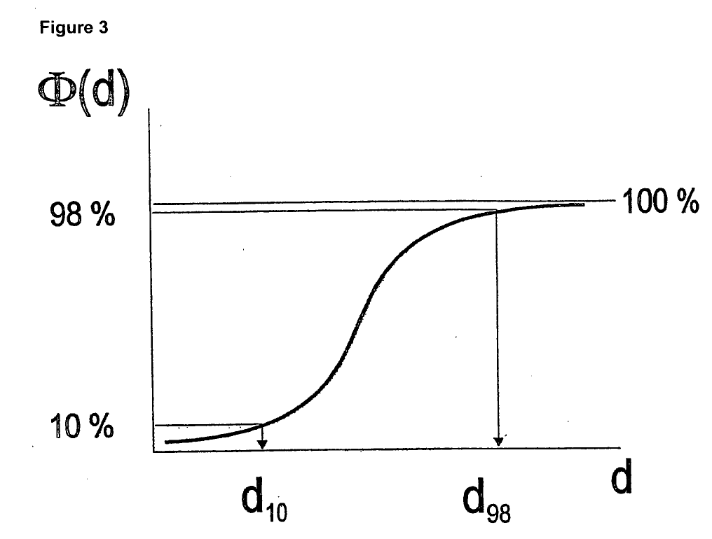

The basis of the determination of d₉₈ and d₁₀ is again the (relative) cumulative curve of the particle size distribution. The point at which the 98% ordinate value cuts the cumulative curve immediately provides the desired d₉₈ value on the abscissa axis, and the point at which the 10% ordinate value cuts the cumulative curve immediately provides the desired d₁₀ value on the abscissa axis (cf. FIG. 3).

### EXAMPLES

The examples below and the comparative example are each monolayer, matt, biaxially oriented films which have been produced on the extrusion line described. The base material used for the film and for use in the masterbatch was polyethylene terephthalate having an SV value of 800. The filler used was silica particles (®Sylysia 430 from Fuji, Japan) having a d₅₀ value of 3.4 μm and a SPAN 98 of 1.4.

### Example 1

Chips of polyethylene terephthalate (PET, prepared via the transesterification process using Mn as the transesterification catalyst, Mn concentration: 100 ppm) were dried at a temperature of 150° C. to a residual moisture content of below 100 ppm and fed to the extruder together with the filler.

Extrusion and subsequent stepwise orientation in longitudinal and transverse direction were then used to produce a film having a total thickness of 12 μm.

Mixture of:

40% by weight of PET

60% by weight of masterbatch composed of 95% by weight of PET and 5.0% by weight of silica particles.

The production conditions in the individual process steps were:

| | | |
|---|---|---|
| Extrusion: | temperatures | 287° C. |
| | temperature of the draw roll | 25° C. |
| Longitudinal | stretching temperature: | 125° C. |
| stretching: | longitudinal stretching ratio: | 4.1 |
| Transverse | stretching temperature: | 130° C. |
| stretching: | transverse stretching ratio | 3.9 |
| Setting: | temperature: | 230° C. |
| | time: | 3 s |

The planar orientation at Δp=0.159 was within the range of the invention. The film had the required low gloss and the required low opacity. In addition, the film could be produced very efficiently, i.e. without tears, and also have the desired processing performance. The film structure and the properties of films produced in this way which have been achieved are shown in Tables 2 and 3.

### Example 2

In Example 1, a film of thickness 23 μm was produced. As a result of this, the speed of the machine was reduced by the thickness factor (output remained constant). In order to achieve the desired planar orientation, the process conditions were slightly modified. This allowed the gloss of the film to be further reduced.

| | | |
|---|---|---|
| Extrusion: | temperatures | 287° C. |
| | temperature of the draw roll | 25° C. |
| Longitudinal | stretching temperature: | 124° C. |
| stretching: | longitudinal stretching ratio: | 4.0 |
| Transverse | stretching temperature: | 129° C. |
| stretching: | transverse stretching ratio | 3.9 |
| Setting: | temperature: | 230° C. |
| | time: | 3 s |

### Example 3

Compared to Example 2, the composition of the film was changed. In addition to the polyethylene terephthalate, 20% by weight of the polymeric component I were now added. The component I had the following composition:

90 mol % of isophthalic acid;

10 mol % of the sodium salt of 5-sulfoisophthalic acid

The addition of component I to the film further improved the transparency of the film.

Mixture of:

20% by weight of PET

20% by weight of the component I

60% by weight of masterbatch composed of 95% by weight of PET and 5.0% by weight of silica particles.

### Comparative Example 1

In comparison to Example 1, the film was produced in such a way that the Δp value did not fulfil the requirements of the present invention. The production conditions in the individual process steps were:

| | | |
|---|---|---|
| Extrusion: | temperatures | 287° C. |
| | temperature of the draw roll | 25° C. |
| Longitudinal | stretching temperature: | 115° C. |
| stretching: | longitudinal stretching ratio: | 4.4 |
| Transverse | stretching temperature: | 121° C. |
| stretching: | transverse stretching ratio | 4.2 |
| | time: | 3 s |

The mattness of the film, the transparency of the film and the producibility have become distinctly worse.

TABLE 2

| | Film | | | Median pigment | Pigment |
|---|---|---|---|---|---|
| | thickness | | | diameter | concentrations |
| Example | [μm] | Film structure | Pigments | [μm] | [ppm] |
| E1 | 12 | mono | Sylysia 430 | 3.4 | 30000 |
| E2 | 23 | mono | Sylysia 430 | 3.4 | 30000 |
| E3 | 23 | mono | Sylysia 430 | 3.4 | 30000 |
| CE1 | 12 | mono | Sylysia 430 | 3.4 | 30000 |

TABLE 3

| | | Median | | Measurements | | | | | |
|---|---|---|---|---|---|---|---|---|---|
| | | roughness | | for the gas | | | Gloss, | | |
| | | Rₐ [nm] | | flow [s] | | | 60° | Opacity | Production |
| Example | COF | External | Internal | External | Internal | Δp | External | [%] | performance |
| E1 | 0.40 | 230 | 232 | 10 | 11 | 0.156 | 25 | 60 | ++ |
| E2 | 0.40 | 250 | 251 | 8 | 8 | 0.156 | 20 | 80 | ++ |
| E3 | 0.41 | 251 | 250 | 6 | 6 | 0.157 | 18 | 60 | ++ |
| CE1 | 0.45 | 210 | 208 | 15 | 16 | 0.166 | 55 | 80 | − |

Key for the production performance of the films:
++ no tears, low production costs
− frequent tears, high production costs of the film

1. A matt, biaxially oriented polyester film which is composed of at least about 60 mol % of a thermoplastic polyester, of pigment systems enhancing the mattness of the film, and of other conventional additives, wherein the planar orientation Δp of the film is about ≦0.164, and it has a gloss which is less than about 80, and the pigments used have a median diameter, d₅₀, in the range from about 2.0 to 8.0 μm, the spread of the distribution of the diameter, expressed via the SPAN 98, being less than/equal to about 1.8.

2. The polyester film as claimed in claim 1, wherein the planar orientation Δp of the film is about ≦0.161.

3. The polyester film as claimed in claim 1, wherein the gloss of the film is below about 70.

4. The polyester film as claimed in claim 1, wherein the thermoplastic polyester present is polyethylene terephthalate, poly-ethylene 2,6-naphthalate, or polyethylene 2,6-naphthalate-bibenzoate, or a mixture of these.

5. The polyester film as claimed in claim 1, wherein the film comprises from about 1.0 to 10.0% by weight of the pigment system.

6. The polyester film as claimed in claim 1, wherein inorganic and/or organic particle systems are present.

7. The polyester film as claimed in claim 1, wherein a said film further comprises reground material in an amount of up to about 60% by weight, based on the total weight of the film.

8. A process for producing a matt, biaxially oriented polyester film, composed of at least about 60 mol % of a thermoplastic polyester, of pigment systems enhancing the mattness of the film, and of other conventional additives, which comprises extruding an appropriate melt through a flat-film die, drawing off the resultant film on one or more rollers for solidification, that being followed by biaxial stretching and then heat-setting and wind-up of the film.

9. The process as claimed in claim 8, wherein pigments are added to the polymers of the film in the respective advantageous concentrations in the form of a glycolic dispersion during polycondensation or by way of masterbatches during extrusion.

10. The process as claimed in claim 8, wherein pigments with a median diameter, d₅₀, in the range from about 2.0 to 8.0 μm are added, the spread of the distribution of the diameter, expressed via the SPAN 98, being about ≦1.8.

11. The process as claimed in claim 8, wherein reground material is added in an amount of up to about 60% by weight, based on the total weight of the film.

12. Packaging film comprising of the polyester film as claimed in claim 1.

13. Packaging film as claimed in claim 12, wherein said packaging film is as flexible packaging or film suitable for use on high-speed packaging machinery.
